(19) United States
(12) Patent Application Publication
(10) Pub. No.: US 2015/0175764 A1
(43) Pub. Date: Jun. 25, 2015

(54) SUSTAINABLE RESIDENTIAL SHEET

(71) Applicant: Armstrong World Industries, Inc., Lancaster, PA (US)

(72) Inventors: Joshua J. LENSBOUER, Mount Joy, PA (US); Steven F. HYNICKA, Mountville, PA (US)

(21) Appl. No.: 14/140,170

(22) Filed: Dec. 24, 2013

(51) Int. Cl. C08J 9/04; B05D 3/00; B05D 1/00; C08J 9/10; C08J 9/08

(52) U.S. Cl. CPC C08J 9/04; C08J 9/105; C08J 9/08; C08J 9/103; C08J 9/107; C08J 9/108; B05D 1/00; B05D 3/007; C08J 2327/06

(57) ABSTRACT

Described herein are surface coverings comprising a support layer; and a vinyl base layer formed from a fluid matrix comprising a virgin vinyl chloride resin, a recycled vinyl chloride resin, a plasticizer, and a blowing agent. Also described are methods of making and using same.

### BACKGROUND

Many plastics are difficult to recycle into usable materials. Although thermoplastics can be re-melted, the properties of the resulting blend of polymers are difficult to control, and the recycling of most mixtures of thermoplastic scrap material may be limited by the incompatibility of the scrap. In most instances, the properties of recycled plastics are sufficiently different from the virgin plastic that extruding and molding the recycled plastic is very difficult. In addition, contamination from incompatible plastics and other foreign materials produce inconsistent properties throughout the plastic and poor quality product.

There is, therefore, a need for recycled polymeric material that exhibits performance properties similar to that of its virgin counterpart and a method of reclaiming and making such recycled polymer products. Embodiments of the present invention are directed to these and other ends.

### SUMMARY

Some embodiments of the present invention provide a surface covering comprising: a support layer; and a fluid matrix comprising a vinyl chloride resin comprising a virgin vinyl chloride resin and recycled vinyl chloride resin; a plasticizer; and a blowing agent.

Other embodiments provide a method of making a surface covering comprising: providing a source of post-consumer or pre-consumer vinyl chloride resin containing scrap material; cryogenically freezing said scrap material; grinding said cryogenically frozen scrap material; mixing said ground scrap material with a plasticizer and blowing agent, to form a fluid matrix; applying said fluid matrix to a support layer; and curing the support layer to which the fluid matrix has been applied.

### DETAILED DESCRIPTION

In some embodiments, the present invention provides a surface covering that comprises a support layer and a fluid matrix. In some embodiments, the fluid matrix comprises a resin, a plasticizer, and a blowing agent.

In some embodiments, the resin comprises a vinyl chloride resin. In some embodiments, the vinyl chloride resin comprises a virgin vinyl chloride resin, a recycled vinyl chloride resin or a combination thereof. In some embodiments, the vinyl chloride resin comprises at least one blending resin and at least one dispersing resin.

In some embodiments, the ratio of dispersing resin to blending resin is from about 3:1 to about 1:1. In some embodiments, the ratio of dispersing resin to blending resin is about 2:1.

In some embodiments, the virgin vinyl chloride resin comprises a vinyl chloride homopolymer. In some embodiments, the virgin vinyl chloride resin comprises a vinyl chloride copolymer.

In some embodiments, the recycled vinyl chloride resin comprises a vinyl chloride homopolymer. In some embodiments, the recycled vinyl chloride resin comprises a vinyl chloride copolymer. In some embodiments, the recycled vinyl chloride resin is a cryogenically frozen vinyl chloride resin.

In some embodiments, the recycled or virgin vinyl chloride copolymer comprises a vinyl chloride monomer and a second monomer selected from a vinyl halide, a vinyl nitrile, a vinyl ester, a vinyl ether, a cyclic unsaturated compound, an acrylic acid and its derivative, a vinylidene compound, an unsaturated hydrocarbon, an unsaturated ester compound, an allyl compound, or a conjugated or a cross-conjugated ethylenically unsaturated compound, and a combination of two or more thereof.

Some embodiments provide a recycled or virgin vinyl chloride copolymer wherein the ratio of the vinyl chloride monomer to the second monomer in a range from about 1:10 to about 10:1; alternatively about 1:9 to about 9:1; alternatively about 1:8 to about 8:1; alternatively about 1:7 to about 7:1; alternatively about 1:6 to about 6:1; alternatively about 1:5 to about 5:1; alternatively about 1:4 to about 4:1; alternatively about 1:3 to about 3:1, alternatively about 1:2 to about 2:1; and alternatively about 1:1.

In some embodiments, the vinyl halide is selected from vinyl bromide, vinyl fluoride.

In some embodiments, the vinyl nitrile is selected from acrylonitrile and methacrylonitrile.

In some embodiments, the vinyl ester is selected from vinyl acetate, vinyl chloroacetate, vinyl butyrate, a fatty acid vinyl ester, and a vinyl alkyl sulfonate.

In some embodiments, the vinyl ether is selected from a vinyl ethyl ether, a vinyl isopropyl ether and a vinyl chloroethyl ether.

In some embodiments, the cyclic unsaturated compound is selected from styrene, mono- or poly-chloro styrenes, coumarone, indene, vinyl naphthalene, vinyl pyridine, vinyl pyrrole and the like.

In some embodiments, acrylate or derivative thereof is selected from methyl acrylate, ethyl acrylate, n-propyl acrylate, isopropyl acrylate, n-butyl (meth)acrylate, sec-butyl acrylate, isobutyl acrylate, cumyl acrylate, n-hexyl (meth)acrylate, n-heptyl (meth)acrylate, n-octyl (meth)acrylate, 2-ethylhexyl (meth)acrylate, 2-methylheptyl (meth)acrylate, n-decyl (meth)acrylate, lauryl (meth)acrylate, cyclohexyl (meth)acrylate, myrystyl (meth)acrylate, n-nonyl (meth)acrylate, palmityl (meth)acrylate, stearyl (meth)acrylate, 2-hydroxyethyl acrylate, 2-hydroxypropyl acrylate, ethyl chloroacrylate, and a combination of two or more thereof.

In some embodiments, the vinylidene compound is selected from vinylidene chloride, vinylidene bromide, vinylidene fluorochloride and the like.

In some embodiments, the unsaturated hydrocarbon is selected from ethylene, isoprene, propene, isobutene, butene and the like.

In some embodiments, the unsaturated ester compound is selected from dimethyl maleate, diethyl maleate, dimethyl fumarate, diethyl fumarate and the like.

In some embodiments, the allyl compound is selected from allyl acetate, allyl chloride, allyl ethylether, and the like.

In some embodiments, the conjugated or cross-conjugated ethylenically unsaturated compound is selected from butadiene, isoprene, chloroprene, 2,3,dimethylbutadiene-1,3-piperylene, divinyl ketone and the like.

Some embodiments provide that the fluid matrix comprises from about 5 wt. % to about 25 wt. % of a recycled vinyl chloride resin. Some embodiments provide that the fluid matrix comprises from about 8 wt. % to about 22 wt. % of a recycled vinyl chloride resin. Some embodiments provide that the fluid matrix comprises from about 9 wt. % to about 20 wt. % of a recycled vinyl chloride resin. Some embodiments provide that the fluid matrix comprises about 10 wt. % of a recycled vinyl chloride resin.

In some embodiments, the fluid matrix further comprises a heat stabilizer. Some embodiments provide that the heat stabilizer is selected from a mixed metal stabilizer; an epoxy compound, and a combination thereof. In some embodiments the fluid matrix comprises from about 0.1 wt. % to about 1 wt. % of a heat stabilizer, alternatively the fluid matrix comprises about 0.5 wt. % of a heat stabilizer.

In some embodiments, the mixed metal stabilizer is selected from a barium-zinc compound; a cadmium-barium-zinc compound; a lead compound; a tin compound; a calcium-zinc compound; and a combination of two or more thereof. In some embodiments, the heat stabilizer is an epoxidized soybean oil.

In some embodiments, the vinyl chloride resin is dispersed within a plasticizer. Some embodiments provide that the plasticizer comprises a monomeric compound, an oligomeric compound, a polymeric compound, or a combination thereof. In some embodiments, the plasticizer consists essentially of a monomeric compound, an oligomeric compound, or a combination thereof. In some embodiments, the plasticizer consists essentially of a monomeric compound.

In some embodiments, the plasticizer has a molecular weight from about 200 g/mol to about 1000 g/mol; alternatively 200 g/mol to about 750 g/mol; alternatively from about 200 g/mol to about 500 g/mol.

In some embodiments, the plasticizer comprises a carboxylic acid ester or derivative of adipic acid, glutaric acid, sebacic acid, azelaic acid, phthalic acid, phthalate, adipate, trimellitate, trimellitic acid, trimellitic anhydride, and a combination of two or more thereof. Some embodiments provide that the plasticizer comprises benzyl butyl phthalate, diisononyl phthalate, dioctyl terephthalate, dibutyl phthalate, dibutoxy ethyl phthalate, butyl octyl phthalate, dihexyl phthalate, dioctyl phthalate, diisooctyl phthalate, dicapryl phthalate, dicapryldioctyl phthalate, diisodecyl phthalate, ditridecyl phthalate, diisononyl cyclohexane, dioctyl adipate, trioctyl trimellitate, and a combination of two or more thereof. In some embodiments, the plasticizer comprises epoxidized soybean oil.

In some embodiments, the ratio of vinyl chloride resin to plasticizer is from about 3:1 to about 1:1. In some embodiments, the amount of vinyl chloride resin to plasticizer is about 2:1.

In some embodiments, the vinyl chloride resin has an average particle size of from about 1 micron to about 150 microns. In some embodiments, the virgin vinyl chloride resin has an average particle size of from about 1 micron to about 150 microns. In some embodiments, the recycled vinyl chloride resin has an average particle size of from about 1 micron to about 150 microns.

In some embodiments, the vinyl chloride resin is suspended in a plasticizer. In some embodiments, the dispersed vinyl chloride resin has an average particle size of from about 1 micron to about 150 microns. In some embodiments, the dispersed vinyl chloride resin has an average particle size of from about 5 microns to about 100 microns. In some embodiments, the dispersed vinyl chloride resin has an average particle size of from about 20 microns to about 75 microns.

In some embodiments, the fluid matrix may further comprise a tackifier. In some embodiments, the tackifier comprises one or more types of polyvinyl butyral, poly alpha methyl styrene, and a combination thereof. Some embodiments provide that the polyvinyl butyral may be virgin, recycled, or a combination thereof. In some embodiments, the fluid matrix comprises from about 0.5 wt. % to about 4 wt. % of a tackifier; alternatively from about 0.75 wt. % to about 1.5 wt. % of a tackifier.

In some embodiments, the fluid matrix further comprises a filler. In some embodiments, the filler comprises a material selected from limestone, clay, talc, ground shells from claims or coral, quartz, ceramic powder, glass, fly ash, concrete powder, a lignocellulostic component, bamboo, and a combination of two or more thereof. Some embodiments provide a lignocellulostic component comprising wood flour, saw dust, walnut shells, rice hulls, corn cob grit, cork, oak, hardwood, eucalyptus, acacia, birch, palm wood, rubber wood, mulberry wood, Forrest Stewardhip Council certified wood species, coir, jute, seagrass, straw, and a combination of two or more thereof.

Some embodiments provide a fluid matrix comprising from about 10 wt. % to about 20 wt. % of filler.

In some embodiments the fluid matrix comprises a blowing agent. Some embodiments comprise a blowing agent selected from: azodicarbonamide (ADC); 4,4-oxybis(benzenesulfonylhydrazide) (OBSH); P-toluenesulfonylhydrazide (TSH); P-tolyenesulfonylsemicarbazide (PTSS); dinitrosopentamethylenetetramine (DNPT); sodium bicarbonate; 5-phenyltetrazole (PT); and a combination of two or more thereof.

In some embodiments, the fluid matrix comprises from about 0.05 wt. % to about 5 wt. % of a blowing agent. In some embodiments, the fluid matrix comprises from about 0.5 wt. % to about 1 wt. % of a blowing agent.

In some embodiments, the fluid matrix further comprises an additional component selected from a pigment, an antimicrobial agent, a mildewcide, a UV and light stabilizer, an antioxidant, a flame retardant, a compatibilizer, a lubricant, and a combination of two or more thereof. Internal and external lubricants utilized in the plastics industry may be used to aid in the processing of the core. In some embodiments, the lubricant is selected from: calcium stearate, an ester, paraffin wax, amide wax, and a combination of two or more thereof.

In some embodiments, the support layer comprises an inorganic component. In some embodiments, the inorganic component comprises fiberglass.

In some embodiments, the support layer comprises a fibrous component. Some embodiments provide a fibrous component comprising a fiber, a filament, a roving, a chopped strand, a woven or nonwoven fabric, or a combination thereof.

In some embodiments, the support layer is a floor. In some embodiments, the floor is selected from a subfloor and a floor covering.

In some embodiments, the method of making a surface covering comprises providing a source of post-consumer or pre-consumer vinyl chloride resin containing scrap material. In some embodiments, method includes feeding a recycled vinyl chloride resin into a granulator, whereby it is shredded, comminuted or otherwise cut into relatively small pieces. In some embodiments, the vinyl chloride resin may be a homopolymer, copolymer, or a combination thereof—as previously discussed. In some embodiments, the pieces are then conveyed to a cryogenic freezer, whereby the pieces are chilled for a predetermined period of time.

In some embodiments, the temperature range for the cryogenic freezing ranges from about −80° C. to −160° C.; alternatively from about −100° C. to about −120° C. In some embodiments, the cryogenic freezing can be accomplished using a number of freezants including: liquid nitrogen (−196° C.), solid carbon dioxide (−78.5° C.), and CCl2F2 refrigerant (−30° C.). In some embodiments, the freezant is sprayed into the freezer to chill the recycled vinyl chloride resin. In some embodiments, the pieces are cryogenically embrittled by chilling the pieces for a period of time necessary to freeze the recycled vinyl chloride resin below its glass-transition temperature.

Some embodiments provide that after cryogenically freezing the pieces recycled vinyl chloride resin, the pieces are transferred to a rotary impact mill where the recycled pieces of vinyl chloride resin are impacted and agitated. In some embodiments, the rotary mill is supplied with cold gas, such as nitrogen, to ensure the milling temperature remains at or below about 30° C.; alternatively at or below 20° C.; alternatively at or below 10° C.; alternatively at or below 0° C.

In some embodiments, the recycled pieces of vinyl chloride resin are then transferred from the rotary impact mill to a vibratory screener. In some embodiments, the vibratory screener may be a single-deck or a multi-deck vibratory screener. In some embodiments, the multi-deck screener has the same or a different sized sieve screens. Some embodiments provide that each sieve of the multi-deck vibratory screener is capable of providing average particles sizes up to about 150 microns; alternatively up to about 125 microns; alternatively up to about 100 microns; alternatively up to about 75 microns; alternatively up to about 50 microns; alternatively up to about 25 microns.

In some embodiments, the screened recycled vinyl chloride resin is then mixed with plasticizer. In some embodiments, the average size of the recycled vinyl chloride resin in the mixture ranges from about 1 to about 150 microns; alternatively from about 5 to about 100 microns; alternatively from about 20 microns to about 75 microns. In some embodiments, the vinyl chloride resin may be pre-heated before mixing with the plasticizer. In some embodiments, the plasticizer may be pre-heated before mixing with the vinyl chloride resin. In some embodiments, to avoid thermal degradation of the vinyl chloride resin, the mixture is maintained at a temperature below about 200° C.; alternatively the mixture is maintained at a temperature below about 150° C., alternatively the mixture is maintained at about 100° C.

Some embodiments provide that the vinyl chloride resin and plasticizer are mixed in a mixing device, such as a paddle-type device or a continuous screw mixer. Some embodiments provide that the plasticizer is added to the mixing device first, followed by the addition of the vinyl chloride resin, wherein the recycled and virgin vinyl chloride resins are added concurrently, the recycled vinyl chloride resin is added before the virgin vinyl chloride resin, or the virgin vinyl chloride resin is added before the recycled vinyl chloride resin. In some embodiments, the plasticizer, virgin vinyl chloride resin and recycled vinyl chloride resin are added concurrently. In some embodiments, the virgin vinyl chloride resin may be pre-heated before being added to the mixing device.

In some embodiments, a solvent may be added to the mixing device. In some embodiments, the solvent comprises a ketone having 3-8 carbon atoms, both aliphatic and alicyclic, such as acetone, methylethyl ketone, Z-penanone, S-pentanoe, methylisobutyl ketone, methylisoamyl ketone, cyclopentanone, cyclohexanone, hexanones, heptanones, octanone, acetophenone, propiophenone, isophorone, and the like; esters having 4-10 carbon atoms, both aliphatic and alicyclic, such as ethyl acetate, ethyl propionate, butyl acetate, amyl acetate, ethylene carbonate, ethyl benzoate, and the like; ethers having 5-10 carbon atoms, both aliphatic and alicyclic, such as dibutyl ether, tetrahydrofuran, dioxane, ethylene glycol dimethyl ether, and the like; N-alkyl substituted amides having 5-10 carbon atoms, such as dimethyl formarnide, N-methyl pyrollidone, and the like; aromatic hydrocarbons having 7-10 carbon atoms, such as toluene, xylene, and the like; and chlorinated hydrocarbons containing 1-4 carbon atoms such as carbontetrachloride, ethylene dichloride, propylene dichloride, 1,1,1-trichloroethane, and the like.

In some embodiments, the solvent may be added to the mixing device at room temperature, or the solvent may be pre-heated to about reflux temperature. Some embodiments provide that the solvent may be added first to the plasticizer, virgin vinyl chloride resin, or recycled vinyl chloride resin. In some embodiments, the solvent may be added to the final mixture of plasticizer, virgin vinyl chloride resin, and recycled vinyl chloride resin. In some embodiments, the solvent may be added to a mixture of recycled vinyl chloride resin and virgin vinyl chloride resin before the addition of the plasticizer. In some embodiments the amount of solvent ranges from about 1 wt. % to about 50 wt. % based on the weight of the plasticizer, recycled vinyl chloride resin, and virgin vinyl chloride resin. In some embodiments, the method of making a surface covering may use no solvent.

In some embodiments, after all the vinyl chloride resin has been mixed together with the plasticizer the mixture may be transferred to a rotary vacuum dryer to remove any solvent that may have been added to the mixture. In some embodiments, additional resin, filler, blowing agents, and stabilizers can be added to the solvent-less mixture of vinyl chloride resin and plasticizer using mixing equipment, such as a rotary mixer, a banbury mixer, or a continuous mixer.

In some embodiments, the resulting fluid matrix may be useful in non-limiting embodiments such as a coating on a support layer.

Some embodiments provide a method of making a surface covering comprising: providing a source of post-consumer or pre-consumer vinyl chloride resin containing scrap material; cryogenically freezing said scrap material; grinding said cryogenically frozen scrap material; mixing said ground scrap material with a plasticizer and a blowing agent, to form a fluid matrix; applying said fluid matrix to a support layer; and curing the support layer to which the fluid matrix has been applied.

The invention will be described in greater detail by way of specific examples. The following examples are offered for illustrative purposes and are not intended to limit the invention in any manner. Those skilled in the art will readily recognize a variety of noncritical parameters, which can be changed or modified to yield essentially the same results.

### EXAMPLES

### Example 1

The composition of an exemplary surface covering system of the present invention is provided below in Table 1. Diisononyl phthalate has been abbreviated as “DINP.” Benzyl butyl phthalate has been abbreviated as “BBP.” Epoxidized soybean oil has been abbreviated as “ESO.” The limestone has been filtered through a 325 mesh sieve. The lubricant comprises C9-C16 alkyl distillates.

TABLE 1

| | I |
|---|---|
| Ingredient | Wt. % |
| Blending PVC resin | 13.49 |
| Dispersing PVC resin | 30.93 |
| Limestone | 13.5 |
| DINP | 18.1 |
| BBP | 8.8 |
| ESO | 0.5 |
| Recycled PVC | 9.48 |
| Lubricant | 1.3 |
| TiO2 | 2.6 |
| ZnO | 0.5 |
| Blowing Agent | 0.8 |

### Example 2

Post-industrial vinyl scrap is cryogenically frozen and ground to a particle size of less than 150 microns and then suspended in a gel-layer plastisol. The recycled plastisol composition is mixed with a plastisol composition comprising virgin vinyl, wherein the recycled plastisol comprises about 9.5 wt. % of the plastisol mixture. The plastisol mixture is then drawn down onto a 20 milli-inch felt and cured at 140 deg. C. for about 120 seconds.

### Example 3

An exemplary sheet of the present invention, such as the one described above in Example 2, is expanded without a wear layer to verify that expansion can occur. Expansion is observed at 2.5 times the application.

### Example 4

An exemplary sheet is analyzed to evaluate its expected performance. The analysis demonstrated that an exemplary sheet of the present invention which contained approximately 10 wt. % of a recycled vinyl chloride resin provided a structure consistent with the sheet prepared using a virgin vinyl chloride resin alone. A cross-section taken of the exemplary sheet did not show any anomalies, which was truly unexpected.

It is intended that any patents, patent applications or printed publications, including books, mentioned in this patent document be hereby incorporated by reference in their entirety.

As those skilled in the art will appreciate, numerous changes and modifications may be made to the embodiments described herein, without departing from the spirit of the invention. It is intended that all such variations fall within the scope of the invention.

1. A surface covering comprising:
a support layer; and
a vinyl base layer formed from a fluid matrix comprising:
a vinyl chloride resin comprising a virgin vinyl chloride resin and a recycled vinyl chloride resin;
a plasticizer; and
a blowing agent.

2. The surface covering of claim 1, wherein the virgin vinyl chloride resin or the recycled vinyl chloride resin comprises a vinyl chloride homopolymer.

3. The surface covering of claim 1, wherein the virgin vinyl chloride resin or the recycled vinyl chloride resin comprises a vinyl chloride copolymer.

4. The surface covering of claim 3, wherein the vinyl chloride copolymer comprises a vinyl chloride monomer and a second monomer selected from: vinyl acetate, a methacrylate-based monomer; and a combination thereof.

5. The surface covering of claim 1, wherein the vinyl base layer formed from a fluid matrix comprises from about 5 wt. % to about 25 wt. % of a recycled vinyl chloride resin.

6. The surface covering of claim 1, wherein the vinyl base layer formed from a fluid matrix comprises about 9.5 wt. % of a recycled vinyl chloride resin.

7. The surface covering of claim 1, wherein the vinyl base layer formed from a fluid matrix further comprises a heat stabilizer selected from a mixed metal stabilizer; an epoxy compound and a combination thereof.

8. The surface covering of claim 1, wherein the vinyl chloride resins are suspended within the plasticizer.

9. The surface covering of claim 1, wherein the virgin vinyl chloride resin and the recycled vinyl chloride resin have an average particle size of from about 1 to about 150 microns.

10. The surface covering of claim 1, wherein the ratio of vinyl chloride resin to plasticizer is from about 3:1 to about 1:1.

11. The surface covering of claim 1, wherein the recycled vinyl chloride resin is a cryogenically frozen vinyl chloride resin.

12. The surface covering of claim 1, wherein the blowing agent is selected from: Azodicarbonamide (ADC); 4,4-Oxybis(benzenesulfonylhydrazide) (OBSH); P-toluenesulfonylhydrazide (TSH); P-tolyenesulfonylsemicarbazide (PTSS); Dinitrosopentamethylenetetramine (DNPT); sodium bicarbonate; 5-phenyltetrazole (PT); and a combination of two or more thereof.

13. The surface covering of claim 1, wherein the plasticizer is a liquid plasticizer.

14. The surface of claim 1, wherein the blowing agent is present in an amount of from about 0.05 wt. % to about 5 wt. %.

15. The surface covering of claim 1, further comprising a filler selected from: pecan shells; wood flour; saw dust; walnut shells; rice hulls; corn cob grit; ground shells from clams or coral; limestone; quartz; ceramic powder; glass; fly ash; concrete powder; and a combination of two or more thereof.

16. The surface covering of claim 1, wherein the support layer comprises a fibrous component.

17. The surface covering of claim 16, wherein the fibrous component comprises a fiber; a filament; a yarn; a roving; a chopped strand; a woven or nonwoven fabric; or a combination of two or more thereof.

18. The surface covering of claim 1, wherein the surface is a floor.

19. A method of making a surface covering comprising:
providing a source of post-consumer or pre-consumer vinyl chloride resin containing scrap material;
cryogenically freezing said scrap material;
grinding said cryogenically frozen scrap material;
mixing said ground scrap material with a plasticizer and a blowing agent, to form a fluid matrix;
applying said fluid matrix to a support layer; and
curing the support layer to which the fluid matrix has been applied.

20. The method of claim 19, wherein the cryogenically frozen scrap material is ground to an extent sufficient to provide an average particle size of from about 1 to about 150 microns.
